(19) United States
(12) Patent Application Publication
(10) Pub. No.: US 2018/0310471 A1
(43) Pub. Date: Nov. 1, 2018

(54) ELECTRIC MOWER WITH AUTOMATIC BLADE UNBLOCKING AND METHOD FOR CONTROLLING THE MOWER

(71) Applicant: PELLENC (Societe Anonyme), Pertuis (FR)

(72) Inventor: Roger PELLENC, Pertuis (FR)

(21) Appl. No.: 15/770,318

(22) PCT Filed: Dec. 6, 2016
(86) PCT No.: PCT/FR2016/053228

§ 371 Date: Jun. 21, 2018

(30) Foreign Application Priority Data
Dec. 23, 2015 (FR) 15/63189

(51) Int. Cl. A01D 34/00; A01D 34/68; A01D 34/74; A01D 34/78; A01D 34/685

(52) U.S. Cl. CPC A01D 34/006; A01D 34/6818; A01D 2101/00; A01D 34/78; A01D 34/685; A01D 34/74

(57) ABSTRACT

An electric mower has an electric motor driving at least one rotary cutting blade. A method for controlling the mower includes: a rest phase during which the electric motor is not powered; a mowing phase during which the electric motor is controlled to rotate in a first direction of rotation, corresponding to the rotation of the cutting blade in a plant cutting direction; and a temporary blade start phase, in which the electric motor is temporarily controlled to rotate in a second direction opposite the first direction of rotation. The mower and method are applicable to mowers and brushcutter mowers.

### TECHNICAL FIELD

The present invention relates to an electric mower of the battery-operated type, provided with an automatic blade unblocking function. It also relates to a method for controlling such a mower, and in particular for its blade drive motor.

The invention finds applications in the area of battery-operated lawn mowers or brush mowers, used for the upkeep of private or public green spaces. It can be applied on walk-behind or riding mowers, or even on autonomous robotic mowers.

### STATE OF PRIOR ART

Mowers used for the upkeep of green spaces feature mostly a cutter casing which houses at least one rotary blade, and a blade drive motor. The motor may be a thermal engine or an electric motor. Each blade may be driven by its own motor or all blades may be driven by a single motor.

Unless the cutter casing is meticulously maintained, it does happen that grass clippings adhere to the casing and end up forming solid clumps there. These clumps, once they reach a certain size, constitute obstacles to the free rotation of the blades. An accumulation of plant material can also occur when, during the mowing operation, a quantity of plant material reaching the cutting blade(s) exceeds the cutting and/for evacuation capacity of the mower.

Such accumulations are susceptible of slowing the movement of the cutting blade(s) or even of blocking it or them.

The document EP 2,425,701 proposes modulating the cutting height of an autonomous electric mower, thereby avoiding an overload of the blade while mowing, and thus a jamming of the blade.

This measure leads to an uneven height of the plants and is difficult to transfer to walk-behind mowers, the mowing operation resulting in a mediocre cut from an esthetic point of view. Better uniformity of the cut would in fact require at least one additional pass. Modulating the cutting height is also ineffective against the previously mentioned build-ups of plant material which form after a perfunctory cleaning of the cutter casing or which form suddenly, depending on the conditions of density and humidity of the cut plants.

The accumulations of clippings which encumber the cutter casing, and which hinder the free rotation of the blades can be overcome to a certain extent on mowers equipped with a thermal engine for driving the blades.

In fact, thermal engines, at least some of them, are equipped with recoil starter ropes. Actuation of the starter rope by an operator, to start the motor, generally results in forced rotation of the blades in the cutting direction with a significant torque at the rotation axis of the blade. Also, actuation of the starter rope may, because of this rotation, suffice to dislodge the plant clumps which obstruct the cutter casing.

In contrast, the problem of plant clumps in the cutter casing remains unresolved for electric mowers which have no manual starter ropes. So, when the starting torque of the electric motor is insufficient to overcome the resistance of the plant clumps, the cutting blade(s) remain jammed.

Dislodging the clumps requires in this case an intervention by the user on the blades and particularly in proximity of their cutting portion. Such an intervention is not only time consuming but above all dangerous. It is therefore not desirable.

The document U.S. Pat. No. 7,797,915 describes a reel mower and a reel clearing system using counter-rotation of the reels in response to a signal from a rotation speed sensor.

### DISCLOSURE OF THE INVENTION

The present invention aims to propose an electric mower that does not present the afore-mentioned difficulties.

One aim is in particular to propose an electric mower provided with an automatic un amming or freeing function of the blades, without the user having to intervene on the blades.

One aim of the invention is also to propose an electric mower capable of starting, notwithstanding any plant clumps susceptible of hindering the free rotation of the blades.

Yet another aim of the invention is to propose an electric mower capable of surmounting a clogging situation while mowing, causing a slowing or even a jamming of the blades.

Finally, one aim of the invention is to propose a method for controlling an electric mower achieving automatic freeing of the cutting blade(s).

To attain these aims, the invention relates more precisely to an electric mower comprising:

At least one rotary cutting blade,

A rotary electric motor for driving the cutting blade,
An electronic control unit of the electric motor configured for controlling a rotation of the electric motor in a first direction of rotation during a mowing phase, and for controlling a rotation of said electric motor in a second direction of rotation, in opposition to the first direction of rotation, during a startup phase of the blade.
According to the invention,
   the electric motor is a brush less motor, and
   the control unit is provided with a measuring circuit of an induction current in at east one winding of the electric motor and configured to initiate the blade start-up phase in response to an absence of induction current in the winding of the electric motor.

The control unit can also be configured to detect a possible situation of blade jamming, during a startup of the electric motor, and to automatically initiate the blade startup phase in response to a jamming situation.

In the following disclosure reference is made, for the sake of simplification, to a single cutting blade and a single electric motor for driving the blade. It should however be noted that the mower according to the invention may be equipped with several cutting blades. The cutting blades may be blades turning around an essentially vertical axis, in a mowing position of the mower, or around an essentially horizontal axis. The blades turn around an essentially horizontal axis in the case of mowers provided with a helical cutting reel.

In the case where the mower disposes of several blades, a single electric motor for driving the blades may be provided. Several drive motors, for example one motor per blade, can also be envisaged. The electronic control unit is then configured for controlling the drive motor or motors of the various cutting blades.

The invention is based on the established fact that the obstacle to rotation constituted by a clump of plant material does not necessarily oppose the same resistance to rotation in the two possible directions of rotation of the blade. A slight dislodging movement of the blade often turns out to be possible at least over a fraction of a blade revolution.

The transitory control of the motor in the second direction of rotation during the startup phase of the blade makes it possible to free the blade and, to ensure a free course of the blade, over a portion of blade revolution. If this free course does not entirely free the blade it allows the blade at least to acquire a certain rotation speed and hence a kinetic moment of rotation. The kinetic moment of rotation is used to overcome the possible blockage in the case where the torque alone of the motor would be insufficient. In addition, during that fraction of revolution in the opposite sense to the direction of rotation defined for mowing, the blade may also encounter the possible clump of plant material during its rotation in the opposite direction, thus destabilizing it and diminishing its resistance at the next contact with the blade after it resumes its rotation in the direction of the cutting action.

At the end of the transitory phase of blade startup, rotation in the first direction of rotation can be resumed.

The control unit can moreover be configured to detect a persistent blocking situation of the blade during the startup phase and in order to cause, in this event, a dislodging operation comprising the control of a sequence of rotations of the electric motor alternatively in the first and in the second direction of rotation. This corresponds to a less favorable situation in which a simple counter-rotation in the startup phase is insufficient to unblock the blade. The control of a new rotation sequence in one direction of rotation and then in the inverse direction allows the user to insist and to increase the chances of overcoming the blockage of the blade.

The dislodging operation can be interrupted:
As soon as the blockage situation disappears,
At the end of a predetermined duration, for example a few seconds,
At the end of a predetermined number of inversions of direction, for example about ten inversions.

If the blade fails to become free at the end of the sequence, the energy supply to the motor can be interrupted automatically in order to safeguard the motor and, if applicable, to alert the operator so he can intervene in the proximity of the blade.
The startup phase can be initiated in different ways.
According to a first possibility, the control unit is configured to initiate the blade startup phase automatically at each start of the electric motor driving the cutting blade. In this case, detection of a possibly present blocking situation does not constitute a precondition for the startup phase. A startup of the electric motor is to be understood as a start that may occur after a storage period or a time the mower was out of service, or that may occur in case the rotation stopped while the mower was in use. In the latter case, it is a restart.

Incidentally, the blade startup phase is considered to be initiated automatically when it is initiated in the absence of a command by a user of the mower, specific to the blade startup phase.

A command by the user for the start or restart of the mower is not considered to be a command specific at the blade startup phase.

According to another possibility, and as mentioned above, the control unit can be configured to detect a blade blockage situation during a start of the electric motor driving the cutting blade, and to initiate automatically the blade startup phase in response to the detection of a blockage situation.

Thus, the startup phase is not necessarily initiated in all start cases but can be initiated only if a blockage situation is detected. In this case as well, a blockage situation remains transparent for the operator whose only action is then to launch a mower start.

A blade blockage situation is also indicated by a blockage of the blade drive motor, due to their being coupled in rotation. It is considered that a blockage corresponds either to a total absence of rotation, or to limited rotation less than one revolution, or also a rotation at a speed of rotation that is much inferior, for example by a factor of 10, to a desired speed of rotation.

Finally, as a third possibility, the mower may feature a command interface connected to the motor control unit, the command interface including a trigger element of the blade startup phase. In this case, initiation of the startup phase requires an action by the mower operator on the manual trigger element of the interface, for example a knob, a lever or a pedal.

The existence of a possible trigger of the blade startup phase by the operator does not exclude an automatic trigger as described previously.

For the detection of a blade blocking situation, the control unit may be equipped with a measuring circuit of at least one of an induction current in a winding of the electric motor and an electric supply current of the electric motor.

In the case of a brushless blade drive motor, the measurement of induction currents in the windings of the motor stator is used to determine the position of the rotor and to control the supply currents of the motor. Detection of an absence of induction currents by the rotor, in spite of the electric power supply to the motor, characterizes a blocking situation of the motor and hence of the cutting blade.

A blocking situation can thus be established without a rotation or rotation speed sensor associated to the motor or the cutting blade.

More precisely a measuring circuit of the induction current can be provided for one or several stator windings. Brushless motors of the type used within the context of the invention present in effect a stator with several windings, generally three in number or more to which supply voltages are cyclically applied to make the motor rotate. It is a multiphase voltage controller, such as a three-phase controller for example.

Measurement of the induction current is not a direct measurement, but an indirect measurement established from a measurement of currents in at least two stator windings, for a three-phase motor. The current circulating in the stator windings depends in effect on the voltages applied to the windings, the electric resistance of the windings, the inductions of the windings and on the effect of a back-electromotive force resulting from the movement of the rotor magnets in front of the stator windings. It is the portion of the current resulting from this back-electromotive force, called induction current, which makes it possible to determine the rotation, the absence of rotation and, if applicable, the speed of motor rotation. As indicated before, the induction current is measured indirectly because it is established based on the current measured in several windings and based on the other parameters mentioned above.

It is considered, in this case, that the blockage of the motor is indicative of a blockage of the blade by reason of the coupling in rotation of the motor and the blade. The control unit may also feature a measuring circuit of the supply current. The measurement of the supply current means the current applied either to one or more particular windings of the stator or to all the stator windings. In this case, a blockage situation of the cutting blade and of the motor is characterized by a simple electric overconsumption of the motor. This option is not part of the claimed invention.

As an accessory, the mower may feature an adjustment mechanism for the cutting height. It is, for example, an electric jack, and a jack control unit. It may be configured to increase automatically the cutting height at the blade startup phase or at a jam. The cutting height adjustment mechanism may act, for example, on the position of the mower wheels, on the position of a cutting unit relative to a frame of the mower or also on a height position of the cutting blade relative to a frame of the mower.

By increasing the cutting height at the phase of blade startup it is possible to remove from the blade all or part of the plant material possibly present under the blade or facing the blade at the moment of the startup phase, and thus promote the begin of the rotation of the blade.

A control method of the mower may feature:
At least one rest phase during which the electric motor is not supplied with power,
At least one mowing phase during which the electric motor is supplied with energy and is controlled for rotation in a first direction of rotation, corresponding to a rotation of the cutting blade in a direction for cutting plant material,
At least one transitory blade startup phase during which the electric motor is temporarily controlled for a rotation in a second direction opposite to the first direction of rotation.

The different phases of the method can be initiated or repeated several times. Incidentally, the order of the different phases can be different from the one indicated above.

The mowing phase corresponds to a blade rotation in a direction suitable for cutting possibly present plants to be mowed. It does not necessarily imply the actual mowing of plants, nor the actual presence of plants in the cutting zone of the blade.

In the manner already described, several possibilities are being offered to initiate the blade startup phase. In particular:
The blade startup phase can be initiated automatically at the time of starting the electric motor,
The blade startup phase can be initiated in response to a blade blockage situation being detected at the start of the electric motor.
The blade startup phase can be initiated in response to a blade blockage situation being detected during the mowing phase.
The blade startup phase can be initiated in response to a command by the operator.

It is considered that the blade startup phase is initiated during a start of the motor when it is consecutive to powering up the electric blade drive motor.

Detection of a blade blockage situation can be characterized, as previously described, by an absence of rotation of the motor and/or the blade. It can also be characterized by an abnormally slow rotation speed of the motor.

Thus, and according to a particular implementation of the method, the blade startup phase can be initiated in response to the detection of a rotation speed of the electric motor in the first direction of rotation, that is below a reference speed.

The blade startup phase is transitory to the extent that it is not a permanent mode of operation of the mower. It is followed by the mowing phase, or in case of a persistent blockage of the cutting blade, by a rest phase.

The startup phase is also transitory to the extent that it is preferably limited in duration.

The blade startup phase may be maintained, for example, over a length of time corresponding to a fraction of a revolution of the cutting blade.

The blade startup phase can also be maintained over a length of time corresponding to a number of revolutions of the cutting blade between 0.5 and 5.

At the end of the startup phase, the method may feature either a resumption of the mowing phase or a continuation of the mowing phase.

Incidentally, resumption of the mowing phase, or continuation of the mowing phase respectively, may be conditional of a rotation speed of the motor or of the blade, during the blade startup phase, that is above a reference value.

When the rotation speed is insufficient, or in case of a blockage, the mower can be put in a rest phase. According to another possibility, a dislodging phase including, in the manner already described, an alternation of rotations in the first direction of rotation and in the second direction of rotation, can also be initiated.

Finally, and as mentioned above, the blade startup phase may feature a transitory lifting of a cutting height of the mower.

Other characteristics and advantages of the invention will become clear in the description below in reference to the figures of the drawings. This description is given for illustrative purposes and is not limiting.

### BRIEF DESCRIPTION OF THE FIGURES

FIG. 1 is a perspective view of a walk-behind mower according to the invention.

FIG. 2 is a partial view of the mower of FIG. 1 passing through the drive shafts of cutting blades.

FIG. 3 is a flow chart illustrating the main aspects of a method for controlling the mower.

### DETAILED DESCRIPTION OF MODES OF IMPLEMENTATION OF THE INVENTION

Identical or similar portions of the different figures are marked with the same reference signs so that it is possible to refer from one figure to the other.

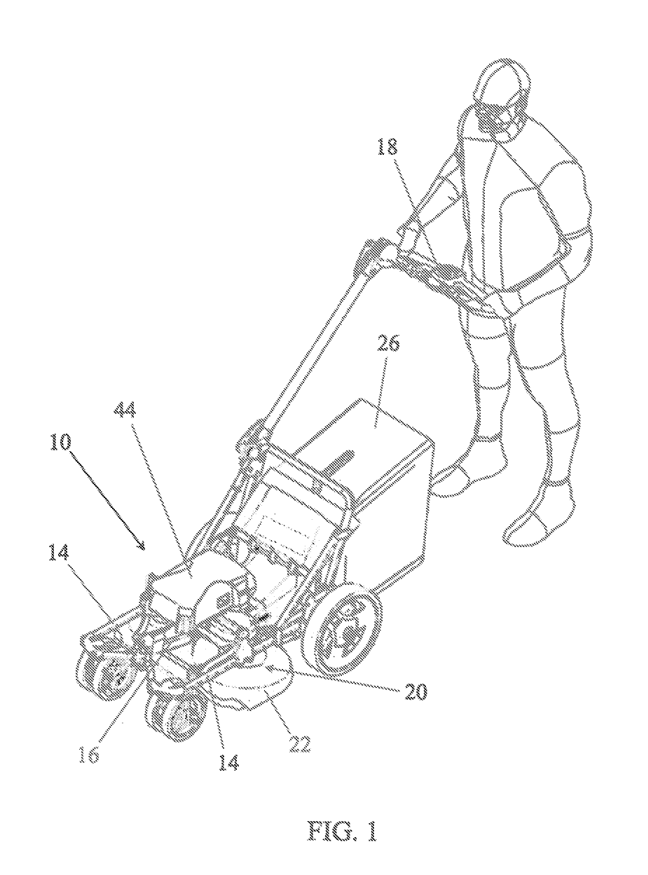

The mower of FIG. 1 is a mower 10 of the walk-behind type. It comprises a cutting unit 20 mounted on a frame 14. The cutting unit is connected to the frame by a parallelogram suspension not visible on FIG. 1. It presents freedom of vertical travel relative to the frame 14 so as to be able to move it closer to or further away from the ground and thereby modify the cutting height. The vertical travel of the cutting unit is performed by an electric jack mechanism 16.

An interface 18 located at the end of a handlebar includes various controls and possibly a visual display unit. It enables the operator to operate the mower by regulating, as needed, its operating parameters.

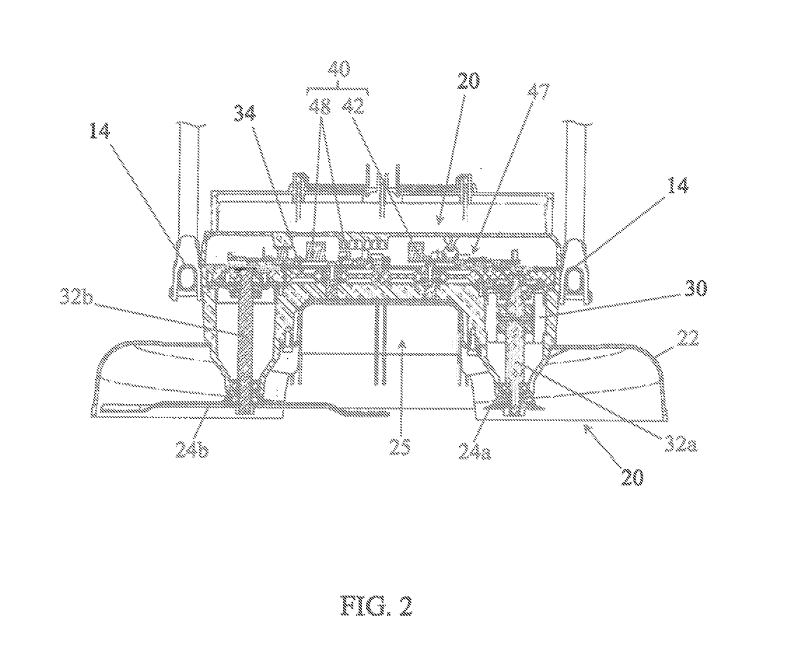

As shown even better on FIG. 2, the cutting unit 20 includes a cutter casing 22 housing two cutting blades 24a, 24b and presenting an elimination channel 25 of the mowed grass clippings towards a collection bin 26 visible on FIG. 1. The cutting unit 20 includes also a blade drive motor 30. It is an electric motor, and in the example shown, it is a brushless motor.

The blade drive motor 30 includes a motor shaft 32a at the end of which is mounted one of the cutting blades 24a. A transmission system 34 with toothed wheels joins together in rotation the motor shaft 32a and a second shaft 32b on which the second cutting blade 24b is mounted. The set of toothed wheels of the transmission system may be replaced by a belt drive. Thus, the two cutting blades 24a and 24b are integral in rotation with each other and in rotation with the drive motor 30.

The cutting unit 20 finally includes a control unit 40 of the electric motor. The control unit includes a first electronic card 42 dedicated to the management of the electric power supply to the motor from a battery 44 visible on FIG. 1. The first electronic card 42 is capable of controlling voltages and a sequence of voltages applied to the different windings of the stator of the motor 30 to set the rotation of the motor, the direction of rotation of the motor and the rotation speed of the motor.

The control unit 40 also includes a second electronic card 47 intended for the determination of an induction current by the rotor in one or more windings of the stator of the motor 30. The second electronic card includes one or more current measuring circuits connected to one or more stator windings. It also receives control data of the motor from the first electronic card 42. Based on the measured currents and based on the induction current derived from it, the second electronic card 47 is able in particular to estimate the position of the rotor in rotation and its movement. This is equivalent to measuring the rotation or absence of rotation of the blades integral in rotation with the motor 30.

The second electronic card 47 and the current measuring circuits may also be used to determine a global supply current of the motor and derive a blockage situation of the motor from an abnormal increase of this current.

Other electronic cards 48 of the control unit 40 are provided for accessory functions of the control unit such as the control of electric motors propelling the mower forward, the control of the electric jack 16 mentioned previously or also of the interface 18.

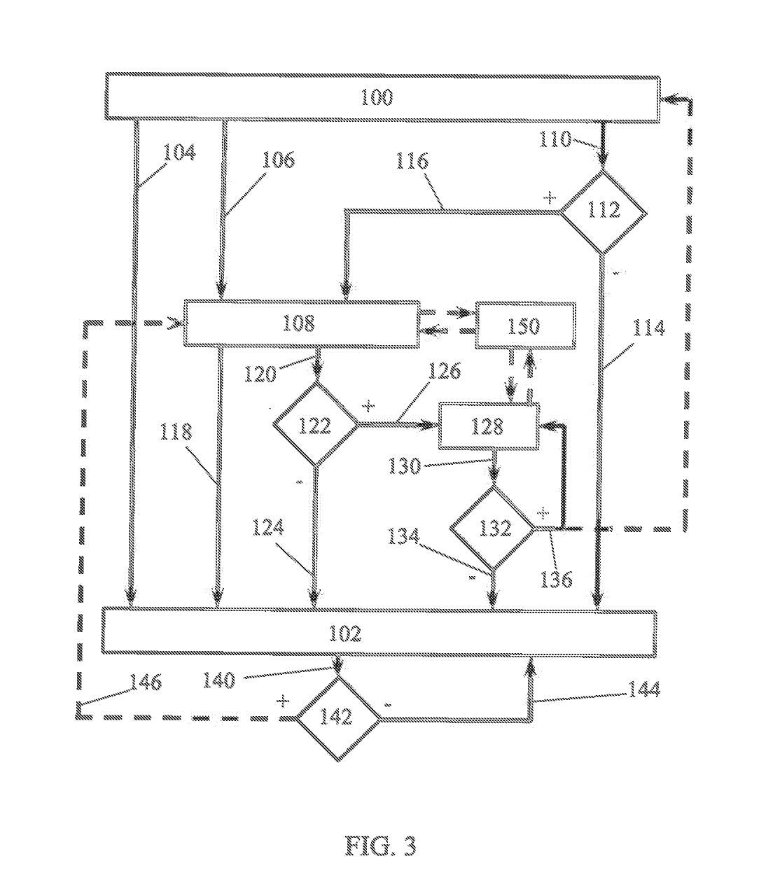

The flowchart of FIG. 3 illustrates the operation of the mower and in particular the control of the electric blade drive motor 30.

The reference 100 of FIG. 3 corresponds to a rest phase of the electric motor 30 in which it is not supplied with power. The motor and the blades do not turn. The rest phase 100 is used for example while the mower is in storage, when it is not in use or during a human intervention on the cutting blades for example.

A startup of the motor can be caused, for example, by an action of the operator on a push button or a key switch of the interface 18 shown on FIG. 1. The startup of the electric motor marks the passage from the rest phase 100 to a mowing phase 102 during which the electric blade drive motor is supplied with power for a rotation in a first direction of rotation. The first direction of rotation corresponds also to a direction of rotation of the blades that is suitable for mowing. In the mowing phase, the mower is usable for mowing plants, and if applicable, for collecting the mowed plant material in the collection bin 26.

In the example shown, the passage from the rest phase 100 to the mowing phase 102 at the moment of startup may take place in three ways.

According to a first possibility, indicated by an arrow 104, the passage from the rest phase to the mowing phase may be immediate. The cutting blades are then activated in rotation in the plant cutting direction.

According to a second possibility indicated by an arrow 106, the passage from the rest phase to the mowing phase may take place through the intermediary of a blade startup phase 108.

As mentioned previously, the startup phase 108 is a transitory phase of short duration during which the electric blade drive motor is powered for a rotation in the second direction of rotation, opposite to the first direction of rotation. The blade startup phase may be accompanied by the command of a lifting 150 of the cutting unit thereby limiting, if necessary, the cut resistance at the cutting blades.

According to a third possibility indicated by an arrow 110, the passage through the startup phase 108 may be conditional on a step 112 of verification of no blade blockage. The verification takes places, for example, by powering the electric motor for a rotation in the first direction of rotation, and by verifying whether the rotation sensor 46 (FIG. 2) emits a rotation signal. When there is no blockage, the verification step 112 is immediately followed by the mowing phase 102 as indicated by an arrow 114. In the opposite case, the verification step may be followed by the blade startup phase 108, as indicated by the arrow 116.

At the end of the blade startup phase 108 the electric motor may pass directly to the mowing phase 102 as an arrow 118 indicates. The startup phase may also include, or be followed by a step 122 of verification of no blockage as indicated by the arrow 120. This step is comparable to the step 112 of verification of no blockage mentioned previously.

As an arrow 124 shows, the verification step 122 of no blockage of the blade startup phase 108 is followed by the mowing phase in the absence of a blockage.

In the opposite case, that is to say when there is a blockage, the blade startup phase 108 is followed, as indicated by an arrow 126, by a dislodging phase 128. The dislodging operation 128 includes, as mentioned previously, a rapid sequence of powering the electric motor in the first and in the second direction of rotation. The dislodging operation amounts, in some way, to repeating several times a blade startup operation in opposite directions of rotation.

A new step 132 of verification of no blade blockage, indicated by the arrow 130, is provided at the end of the dislodging step.

When the verification step 132 is able to observe-an unblocking, that is to say a rotation of the motor, and thus by the blades, it is followed, as the arrow 134 shows, by the mowing phase 102.

Inversely, a failure to unblock noted in the verification step 132, after a predetermined number of rotation attempts in the opposite direction, or after a predetermined duration, is followed, as the arrow 136 shows, by a return to the rest phase so as to possibly perform a maintenance or manual operation to unblock the blades. This return phase is possibly associated to the presentation of a defect signal to the operator (visual or acoustic signal, . . . ).

The reference 142 indicates a possible control operation of the rotation which, as the arrow 140 shows, may take place during the mowing phase 102. This may be a continuous or periodic verification of the rotation of the blade drive motor or a rotation of the blades. It is comparable to the verification steps 112, 122 and 132 mentioned previously.

In case of normal rotation, the mowing phase 102 is continued as indicated by an arrow 144.

In case of a sudden blockage, the control of the motor may repeat the blade startup phase 108 as indicated by an arrow 146. It may possibly be accompanied by a lifting 150 of the cutting unit.

It bears repeating that FIG. 3 only illustrates one particular possibility of controlling the blade drive motor.

1. Electric mower comprising:
at least one rotary cutting blade;
a rotary electric motor for driving the cutting blade;
an electronic control unit of the electric motor configured to control a rotation of the electric motor in a first direction of rotation during a mowing phase, and for controlling a rotation of said electric motor in a second direction of rotation opposite to the first direction of rotation, during a blade startup phase,
characterized in that:
the electric motor is of the brushless type; and
the control unit is equipped with a measuring circuit of an induction current in at least one winding of the electric motor and configured to initiate the blade start-up phase in response to an absence of induction current in the winding of the electric motor.

2. Mower according to claim 1 in which the control unit is also configured to initiate the blade startup phase automatically during each start of the electric motor.

3. Mower according to claim 1, in which the control unit is configured to detect a blockage situation of the blade during the blade startup phase and to cause a dislodging operation comprising the control of a sequence of rotations of the electric motor alternately in the first and in the second direction of rotation.

4. Mower according to claim 1, including an electric adjustment mechanism of a cutting height configured for a transitory lifting of a cutting height of the mower during a blade startup phase.

5. Mower according to claim 1, including a control interface connected to the motor control unit, the control interface including a trigger element of the blade startup phase.
